(19) United States
(12) Patent Application Publication
(10) Pub. No.: US 2009/0048893 A1
(43) Pub. Date: Feb. 19, 2009

(54) System and Method of Role-based Calendaring

(75) Inventors: Li Wang, Beijing (CN); Hai Bo Yu, Beijing (CN); Feng Li Wang, Beijing (CN); John Turek, South Nyack, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 12/120,423

(22) Filed: May 14, 2008

(30) Foreign Application Priority Data
Aug. 15, 2007 (CN) 200710140967.X

(51) Int. Cl. G06Q 10/00

(52) U.S. Cl. 705/8

(57) ABSTRACT

A method for calendaring an activity based on roles, including the steps of acquiring a request for calendaring the activity for a plurality of roles invited to attend the activity; acquiring data on existing activities which have been calendared for all the specific individuals in the plurality of roles invited to attend the activity; and determining the time interval for holding the activity based on the data on existing activities which have been calendared for all the specific individuals in the plurality of roles invited to attend the activity and the request for calendaring the activity.

### CROSS REFERENCE TO RELATED APPLICATION

The present application claims the benefit of priority to a Chinese Patent Application Serial Number 200710140967.X, entitled “System and Method of Role-based Calendaring”, filed Aug. 15, 2007 with the State Intellectual Property Office (SIPO) of the People's Republic of China, the content of which is incorporated herein by reference in its entirety.

### FIELD OF THE INVENTION

The invention relates to a system and method for calendaring an activity based on roles, in particular, a system and method for calendaring an activity, which is capable of coordinating various roles, providing more functions and automatically avoiding conflicts of calendars.

### BACKGROUND OF THE INVENTION

With the development of society, work is divided increasingly finer. Many large enterprises and companies tend to make their internal work more regular. Thus, these large enterprises or companies divide the whole company into a plurality of different function departments. The different function departments in the company take on different tasks and responsibilities. Generally, a project of a company needs to be carried out cooperatively by a plurality of departments of the company being supported mutually. Therefore, the collaboration among the plurality of departments is necessary to carry out the project more effectively. For example, collaboratively arranging a time interval available to a plurality of departments involved in a project so that the plurality of departments or its representative can attend an activity for promoting the project. However, it is difficult to implement the collaboration when a number of departments of a large enterprise and company have to be involved in on project.

With the development of the network technology, many technologies such as network-based electronic calendars, calendar systems, and task systems for a group of users occur. These existing calendaring systems propose a method for calendaring activities or conferences for a plurality of users. These systems generally have a database which contains data on available time intervals and unavailable time intervals of each user. In case that a new conference or activity need to be calendared, the system firstly judge whether all the users invited to attend the activity or conference are available during a predetermined time interval. If it is determined that they are available, the conference or activity is successfully calendared, otherwise, the system will suggest another selectable time interval to ensure a number of invited users as many as possible to attend the activity or conference. If it is determined that all the invited users are unavailable in a predetermined time interval, the system will select a time interval from a predetermined time interval to calendar the activity or conference based on an algorithm, and in the selected time interval the absence rate of the users are the lowest. According to the calendaring process of such system, once it is judged that some or all of the invited individuals are unavailable during the predetermined time interval, the system will select a time interval to ensure a number of invited users as much as possible to attend the activity or conference, or select a time interval, in which the absence rate of the invited individuals are the lowest, to hold activity or conference. In this case, the final calendaring result may be that the individual who takes on an important task in or is necessary for the activity or conference will be absent from the activity or conference. Obviously, such calendaring result is not satisfying. In addition, in the existing calendar systems, the users invited to attend the conference are pure individuals, the calendar system operates based on time and with respect to the pure individuals, the available time state of each user has the same view for all the individuals, and the accessing control mechanism is lacked. Also, the existing calendar systems can not solve the problem that a plurality of activities or conferences calendared in the same one time interval will conflict.

Although some existing calendaring systems propose some methods for resolving the conflicts in calendaring, these methods only simply replace one activity with another activity to resolve the conflict problem based on priority levels of the conflicting activities or conferences. The result is that only one activity or conference of the conflicting activities or conferences will be remained and the other or others will be cancelled.

### SUMMARY OF THE INVENTION

Thus, an object of the invention is to overcome those and other disadvantages occurring in the existing calendar systems.

In order to accomplish those and other objects of the invention, there is provided a method for calendaring an activity based on roles, including the steps of: acquiring a request for calendaring the activity for a plurality of roles invited to attend the activity; acquiring data on existing activities which have been calendared for all the specific individuals in the plurality of roles invited to attend the activity; and determining the time interval for holding the activity based on the data on existing activities which have been calendared for all the specific individuals in the plurality of roles invited to attend the activity and the request for calendaring the activity.

According to another aspect of the invention, there is further provided a system for calendaring an activity by utilizing the method according to any one of the preceding claims, including: inputting section for inputting a request for calendaring the activity for a plurality of roles invited to attend the activity; data collection section for collecting and storing all data relevant to the calendaring; and calendaring section, for acquiring the request from the inputting section, acquiring data from the data collection section on existing activities which have been calendared for all the specific individuals in the plurality of roles invited to attend the activity, and determining the time interval for holding the activity based on the data on existing activities which have been calendared for all the specific individuals in the plurality of roles invited to attend the activity and the request for calendaring the activity.

### BRIEF DESCRIPTION OF THE DRAWINGS

Now, the embodiments of the invention will be described in details only as examples with reference to the drawings, wherein:

FIG. 1 is a flowchart of a basic operation of the calendar system according to the present invention;

FIG. 2 is a flowchart of a calendaring method in one preferred embodiment according to the present invention;

FIG. 3 is a flowchart of a calendaring method in another preferred embodiment according to the present invention;

FIG. 4 is a flowchart of a calendaring method in another preferred embodiment according to the present invention;

FIG. 5 is a block diagram of the architecture of the calendar system according to the present invention; and

FIG. 6 is a model view of the data structure collected and stored in the data collection section according to the present invention.

### DESCRIPTION OF PREFERRED EMBODIMENTS

Below, the present invention will be described in detail with reference to the drawings.

In the following description, some terms involved in the present invention should be defined. The so-called “roles” in the present invention are not pure individuals but a group of ones with a certain role. Particularly, the roles refer to a group of individuals, users or organizations who take on a certain task, such as engineers, lawyers, managers, project managers, directors, market researchers, various function departments and the like. The roles can also be a group of individuals with a certain level. In particular case, a certain role may be a specific individual, such as a director of a company. Sometimes, the roles may be a collection of non-person factors, such as a collection of some locations of the same type and a collection of some apparatuses of the same type etc., a collection of objective facts of one type, such as a collection of flights and a collection of trains from location A and location B during a certain time interval, and a collection of predicted weather during a certain time interval and the like. The so-called “community” in the application is a collection of above-described “roles”, and for example, the community can be a company, a sub-company, a group, a school, a real resident community, a governmental department, an association and the like. The community has specific goals and rules, and is managed by the community owner who can be the community creator or other authorized role. The so-called “calendar” in the application is classified into two categories: private calendar and public calendar. The private calendar is maintained by the role self, while other roles have no right on the private calendar. The public calendar is shared in the community. All roles in the community have the right to access the public calendar, but only the calendar owner has the right to update it. The so-called “activity” in the present application refers to a predefined activity of role. Activity list is a collection of activities. Activities can be classified into two categories: private activity and public activity. The private activity is an inside activity of each role, each role self maintains its own private activity list, and the private activity list can only be used in the private calendar. The so-called “time” in the present application is natural time, and can be measured in terms of years, months, days, hours, minutes and seconds of the Gregorian calendar. Of course, the time can also be further measured in terms of millisecond etc as needed. The so-called “time interval” in the application refers to one time interval of above-described time. The so-called “selectable time interval collection” refers to a collection of time intervals which can be determined as the time interval for holding the activity.

An aspect of the invention is to provide a calendar system and method that can perform calendaring based on roles, especially based on the importance of the roles for the activity but not based on the time and/or pure individuals.

Another aspect of the invention is to provide a calendar system and method that can provide more collaborative functions among various influential factors such as roles, time and activities etc.

Another aspect of the invention is to provide a calendar system and method that can automatically avoid the conflicts among various conferences or activities.

Another aspect of the invention is to provide a calendar system and method that have an access control mechanism.

In order to accomplish these and other objects of the invention, there is provided a method for calendaring an activity based on roles, including the steps of: acquiring a request for calendaring the activity for a plurality of roles invited to attend the activity; acquiring data on existing activities which have been calendared for all the specific individuals in the plurality of roles invited to attend the activity; and determining the time interval for holding the activity based on the data on existing activities which have been calendared for all the specific individuals in the plurality of roles invited to attend the activity and the request for calendaring the activity.

Preferably, the step of acquiring a request for calendaring the activity includes acquiring roles invited to attend the activity, the weight of each role invited to attend the activity relative to the activity, and a plurality of selectable time intervals for holding the activity, wherein the weight corresponds to the importance of the role for the activity.

Preferably, the step of determining the time interval for hold the activity based on the data on the existing activities which has been calendared for all the specific individuals in the plurality of roles invited to attend the activity and the request for calendaring the activity includes: judging the availability of each role invited to attend the activity for the activity based on the acquired data on the existing activities which have been calendared for all the specific individuals in the plurality of roles invited to attend the activity: for each one of the plurality of selectable time intervals, summing the weights of all the roles available to the activity; and selecting a time interval corresponding to the maximum of the weighted sums as the time interval for holding the activity.

The above-described method avoids the drawback in the existing art of calendaring the activity for specific individuals, which causes that the more important individual for the activity can not attend the activity to influence the calendaring of the activity. On the contrary, the above-described method of the invention is to calendar based on roles and a certain role generally consists of more than one pure individuals, therefore, as long as one of those individuals constituting the certain role can attend the activity, it is determined that the role is available to the activity. As a result, the method of the present invention can ensure the activity to be calendared as possible. Further, since the above-described method uses a process of maximizing the weighted sums, it can ensure more important roles to attend the activity as possible.

Preferably, the step of determining the time interval for hold the activity based on the data on the existing activities which has been calendared for all the specific individuals in the plurality of roles invited to attend the activity and the request for calendaring the activity includes: based on the acquired data on the existing activities which have been calendared for all the specific individuals in the plurality of roles invited to attend the activity, judging the availability of each role for the activity; for each one of the plurality of selectable time intervals, summing the weights of all the roles available to the activity; calculating the absolute values of the differences between the maximum of all the weighted sums and each of other weighted sums; and from the weighted sums, each having a absolute value of the difference between the maximum and itself which is less than a predetermined threshold, selecting a weighted sum corresponding to a selectable time interval in which the number of the roles available to the activity is the most, and determining the selectable time interval corresponding to the selected weighted sum as the time interval for holding the activity.

The above-described calendaring method not only lakes the importance of the roles for the activity into account, hut also can perform a process of maximizing the number of roles based on the maximization of the weighted sums.

Preferably, the method of the invention further includes acquiring priority levels which are set for the type of the activity by all the specific individuals of the plurality of the roles invited to attend the activity, wherein the step of determining the time interval for hold the activity based on the data on the existing activities which has been calendared for all the specific individuals in the plurality of roles invited to attend the activity and the request for calendaring the activity includes: judging the availability of each role invited to attend the activity for the activity based on the acquired data on the existing activities which have been calendared for all the specific individuals in the plurality of roles invited to attend the activity; calculating the product of the weight of each available role invited to attend the activity relative to the activity and the priority levels which are set for the activity by all the specific individuals constituting the corresponding available role invited to attend the activity; for each of the plurality of the selectable time intervals, summing the calculated products; and determining a selectable time interval corresponding to the greatest sum of the products as the time interval for holding the activity.

The above-described calendaring method takes not only the importance of the roles for the activity but also the preference of the individual representing the available role for various activities into account, thus, it is possible to calendar activities more properly.

According to another aspect of the invention, there is provided a system for calendaring an activity by utilizing the method according to any one of the preceding claims, including: inputting section for inputting a request for calendaring the activity for a plurality of roles invited to attend the activity; data collection section for collecting and storing all data relevant to the calendaring; and calendaring section, for acquiring the request from the inputting section, acquiring data from the data collection section on existing activities which have been calendared for all the specific individuals in the plurality of roles invited to attend the activity, and determining the time interval for holding the activity based on the data on existing activities which have been calendared for all the specific individuals in the plurality of roles invited to attend the activity and the request for calendaring the activity.

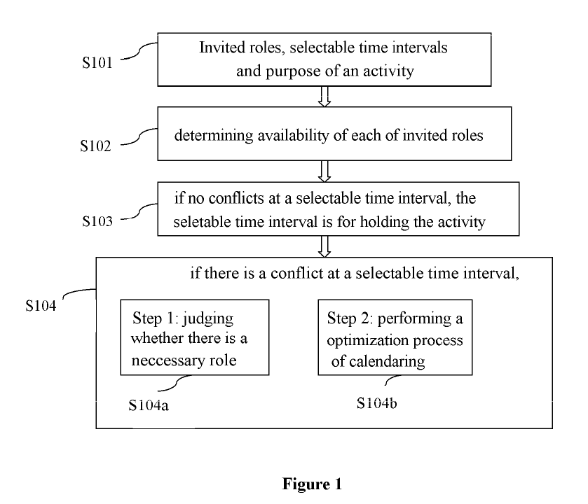

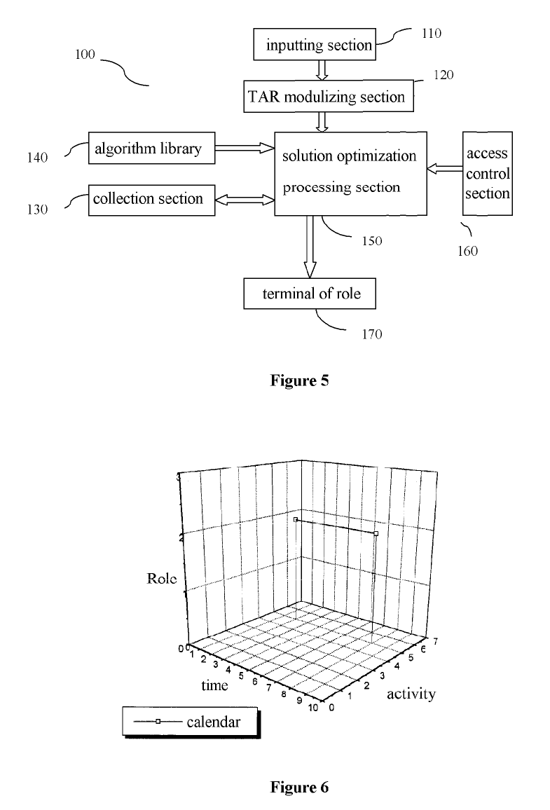

FIG. 1 is a flowchart of a basic operation of the calendar system according to the invention. The configuration of the calendar system will be described later in detail with reference to FIG. 5. First of all, at step S101, the calendar system receives a request for calendaring an activity which at least includes basic information on the activity, such as roles invited to attend the activity, a plurality of predetermined selectable time intervals for holding the activity, and purposes of the activity. The request also includes other information such as locations, required apparatuses and so on.

At step S102, the calendar system judges whether those pure individuals constituting a certain role invited to attend the activity can attend the activity during a certain selectable time interval. As long as one or more pure individuals can attend the activity during the selectable time interval, it is determined that the role is available to the activity during that selectable time interval.

At step S103, if it is determined at step S102 that there is one or more pure individuals in a certain role invited to attend an activity that is currently requested to be calendared during the selectable time interval can attend the activity, the role is set to be available during this selectable time interval. The above judgment process is repeated for each role invited to attend the activity. If all roles invited to attend the activity are available during the selectable time interval, this selectable time interval is set as the time interval for holding the activity.

At step S104, if one or more roles invited to attend the activity have existing calendars conflicting with a certain selectable time interval for holding the activity, that is, all the pure individuals constituting the one or more roles invited to attend the activity can not attend the activity during the selectable time interval, the optimization process should be performed after the above judgment process is repeated with respect to each of the selectable time intervals, so as to select a preferable time interval from all the selectable time intervals to hold the activity. Such selection process is performed by an optimization algorithm. Finally, the selectable time interval corresponding to the optimization result is determined as the time interval for holding the activity.

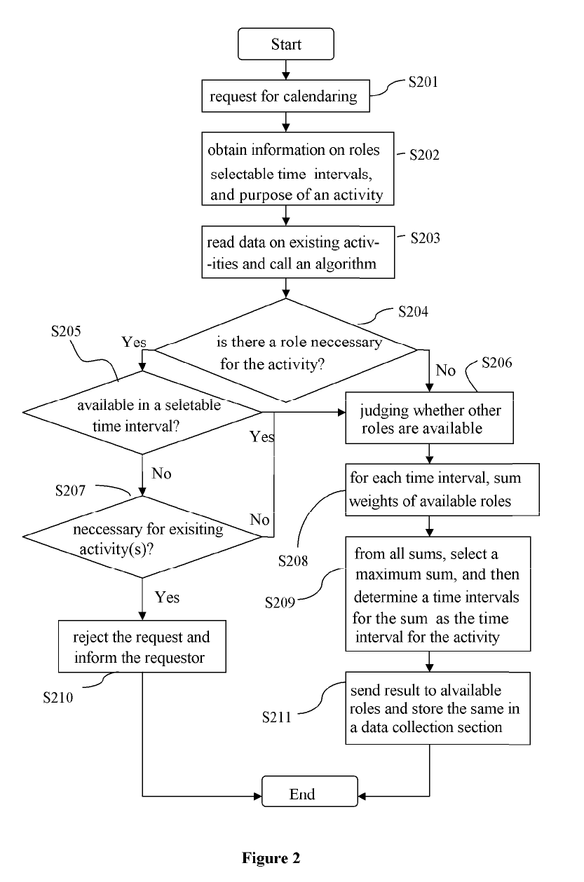

FIG. 2 is a flowchart of the calendaring method in one preferred embodiment according to the invention. As shown in FIG. 2, at step S201, the requestor inputs a request for calendaring an activity. The request at least includes information on roles invited to attend the activity, purposes of the activity, and a plurality of predetermined selectable time intervals for holding the activity. The information on the roles invited to attend the activity includes the weight of each role relative to the activity requested to be calendared (“the activity” hereinafter). With respect to one specific activity, the weights of all the pure individuals constituting one role relative to the activity are the same, regardless of the position or level that each pure individual in the role occupy outside of the activity. The information on selectable time intervals includes the optimum time interval and other time intervals. All the selectable time intervals form a collection of selectable time intervals. The request further includes an optimization goal of the calendaring.

At step S202, the information on the roles invited to attend the activity, selectable time intervals, and purposes of the activity is extracted from the inputted request for the calendaring.

At step S203, based on the inputted request including information on roles invited to attend the activity, all data on existing activities, which have been calendared for all roles invited to attend the activity in all the selectable time intervals before the request being inputted, are read from a database, and a algorithm of maximizing the weighted sums is called from an algorithm library. At step S203, the present invention determines the algorithm of maximizing the weighted sums as the default optimization algorithm. Of course, respective communities can set different default algorithms as desired

At step S204, base on the information on the weights of the roles invited to attend the activity in the request, it is judged whether there are some of roles invited to attend the activity necessary for the activity, and how many roles are necessary. Generally, the weight 1 is given to the necessary role, while the weights less than 1 are given to other roles.

If it is judged at step S204 that there are some necessary roles of all the roles invited to attend the activity, the process proceeds to step S205, otherwise, the process proceeds to step S206. At step S205, it is judged whether the roles necessary for the activity are available during a certain time interval. If it is judged they are available, the process proceeds to step S206, otherwise, the process proceeds to step S207.

At step S207, based on the data read at the step S203 on existing activities which have been previously calendared for all the pure individuals constituting the roles necessary for the activity, it is judged whether the roles necessary for the activity are necessary for the existing activities which have been previously calendared for the roles in the selectable time intervals. If it is determined the roles are necessary for all the activities previously calendared in the selectable time intervals, the process proceeds to step S210, otherwise, the process proceeds to step S206.

At step S210, the request for calendaring the activity is rejected, and the requestor for calendaring the activity will be informed of such rejection result.

If there is a plurality of roles necessary for the activity, then the processes at step S205 and at S207 are repeated. However, in the repeated processes, as long as it is determined that one necessary role are not available to the activity, the process proceeds directly to S210, without performing the processes of judgments at S205 and at S207 for the rest necessary roles. The process can be expressed by the following formula:

$$CoCa = \{ \begin{matrix}0 & ∃ {W}_{( i , ON / OFF )} ⋂ {W}_{( i , ON / OFF )} = 0 , i ∈ [ 0 , n ] \\ TS & the others\end{matrix}$$

The above formula means that, if the i^{th} role is necessary for a certain activity and can not attend it, the activity should be re-calendared. Otherwise (i.e., if no role is necessary for the activity, or necessary role(s) is available to the activity), the present invention will select a time interval from a plurality of selectable time intervals to hold the activity.

At step S206, for each selectable time interval, the availabilities of the remaining roles are determined, and the determination result is stored in a memory.

At step S208, for each selectable time interval, the weights of the roles available to the activity are summed.

At step S209, the weighted sums for the selectable time interval are compared with each other to obtain a maximum from the weighted sums and determine a time interval corresponding to the maximum weighted sum as the time interval for holding the activity.

According to the invention, an algorithm of maximizing the weighted sums may be expressed by the following formula:

$$TS = {\sum }_{i = 1}^{n} ( TS ⋂ {TS}_{i} ) * {w}_{i} \to MAX$$

Wherein, TS is a selectable time interval, TSᵢ is a selectable time interval (s) during which the i^{th} role is available, and wᵢ is the weight of the i^{th} role for the activity.

At step S211, as a result of the calendaring for the activity, concluded data on a list of roles available to the activity, the selected time interval for holding the activity, and the purpose of the activity are sent to the roles available to the activity in the selected time interval (i.e. a pure individual in each available role) and the data are modeled. The modelized data are stored in the data base to fill TAR model.

In addition, at step S205, judging whether a necessary role is available during a selectable time interval is performed by judging whether each of the pure individuals constituting the necessary role is available during the selectable time interval. Similarly, at step S206, judging whether a role is available during a selectable time interval is performed also by judging whether each of the pure individuals constituting the role is available during the selectable time interval. Thus, at step S211, the final calendar data will be sent to the pure individual representing the role. Which pure individual is designated to represent the available role to receive the calendar result can be determined through different ways, for example, through random selection from the available pure individuals of the role invited to attend the activity or through a selection based on the position levels of the available individuals of the role. However, how to designate a pure individual represent a role is not necessary for implementing the invention and the persons skilled in the art can designate the pure individual to represent the role based on a special application.

In addition, it is noted that, for one pure individual, he/she may act as different roles in different activities. The step of determining the availability of a role cannot be completed until finishing judging the availabilities of all the pure individuals constituting the role, until finding a pure individual of the role who can attend the activity, or until determining that the role can not attend the activity. Also, each role has different weights for different activities.

Further, during calendaring the activity, there may be a condition that the activity needs a plurality of roles of the same kind to attend. That is, the activity requires a plurality of pure individuals acting as the same role to attend. In this condition, these roles of the same kind invited to attend the activity can be looked as the roles of different kinds having the same weight. Thus, different numbers will be given to each of these same roles. For example, if an activity need three engineers (a kind of role acting as an engineer) to attend the activity, the numbers R4, R5 and R6 are respectively given to the three roles of the same kind (only for making an example, not a limitation). Each of the three roles of the same kind will subject to the processes as mentioned above. For example, in judging the availabilities of the three roles of the same kind, the availability of R4 is firstly judged. If R4 is unavailable, the rest roles of the same kind (i.e. R5 and R6) will be directly judged to be unavailable. If R4 is available, the availability of R5 is continuously to be judged. If R5 is unavailable, the rest of roles of the same kind (i.e. R6) will be directly judged to be unavailable. If R5 is available, the availability of R6 is continuously to be judged. In judging the availabilities of a plurality of roles of the same kind, if the preceding role of the same kind is judged to be available, an available pure individual in the role will be marked so that the marked pure individual is judged to be unavailable when judging the availabilities of the next role of the same kind. Alternatively, availabilities of a plurality of roles of the same kind can be judged together. For example, if an activity needs three roles of the same kind to attend, availability of each pure individual constituting the same role can be judged directly. If only one pure individual is available to the activity, one of the three roles of the same kind will be randomly determined to be available, and other two will be unavailable. If two pure individuals are available, two of the three roles of the same kind will randomly be determined to be available, and the rest one will be unavailable. If three or more pure individuals are available, all three roles of the same kind will be determining to be available.

In addition, at step S207, there may be provided a means for solving conflicts of calendars. Using the means for solving conflicts of calendars, if the role is necessary for the activity but not necessary for existing activity(s) which has been previously calendared for the role (i.e., a pure individual in the role) during selectable intervals, the role will be re-considered to be unavailable to the existing activity(s) which has been previously calendared for the role but, therefore, the role will be determined to be available for the activity during the selectable intervals. Thus, the conflicts problem of calendars is resolved based on the importance of the role. As to those replaced existing activity(s) which has been previously calendared for the role, they will be re-calendared according to the method of optimizing calendaring process proposed in the present invention.

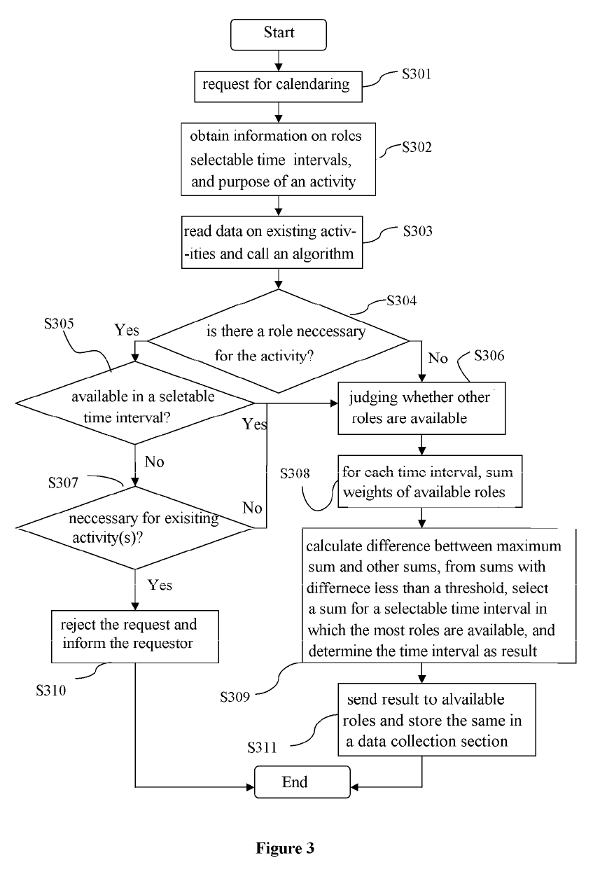

FIG. 3 is a flowchart of the calendaring method in another embodiment according to the invention. The calendaring method shown in FIG. 3 has some of steps similar to those included in the calendaring method shown in FIG. 2, so the description of those same steps will be omitted for briefness. In the calendaring method shown in FIG. 3, at step S303, based on the inputted request including information on roles invited to attend the activity, all data on existing activities, which have been calendared for all roles invited to attend the activity in all selectable time intervals before the request being inputted, are read from a database, and a algorithm of maximizing the number of roles based on the maximization of the weighted sums is called from an algorithm library. The algorithm of maximizing the number of roles based on the maximization of the weighted sums according to the invention can be expressed by the following formula:

$$∃ {TS}_{1} , ∃ {TS}_{2} , if \vert {\sum }_{i = 1}^{n} ( {TS}_{1} ⋂ TS ) * {w}_{i} - {\sum }_{i = 1}^{n} ( {TS}_{2} ⋂ TS ) * {w}_{i} \vert \leq σ , \\ then {TS}_{result} = {TS}_{j} with MAX ( NUM ( {TS}_{1} ) , NUM ( {TS}_{2} ) )$$

Wherein, TS is a selectable time interval, TSᵢ is a selectable time interval (s) during which the i^{th} role is available, and wᵢ is the weight of the i^{th} role for the activity, and σ is a predefined threshold, which is normally a very small value. The threshold σ is a fixed value initially set. Alternatively, the threshold σ is a value set based on an optimization algorithm under a particular condition, and therefore, the threshold will vary with the activities.

The above formula means that, if difference between two weighted sums of available roles which correspond to two selectable time intervals TS1 and TS2 respectively is less than a predefined threshold σ, the numbers of available roles during two time intervals TS1 and TS2 are respectively counted, and the selectable time interval corresponding to the greater number of the available roles is determined as the time interval for holding the activity. Thus, based on the above optimization algorithm, at step S309, absolute value of difference between the maximum of all the weighted sums and each of other weighted sums is calculated, and from the weighted sums, each having a absolute value of the difference between the maximum and itself which is less than a predetermined threshold, a weighted sum corresponding to a selectable time interval, in which the number of the roles available to the activity is the most, is selected, and the selectable time interval corresponding to the selected weighted sum is determined as the time interval for holding the activity.

This algorithm of maximizing the number of roles based on the maximization of the weighted sums is more suitable for calendaring a declaring activity. For a declaring activity or an experiencing activity, the object of which is to allow the invited roles as many as possible to attend the activity to have an experience on the activity, and therefore, the above object can be realized through the optimization algorithm.

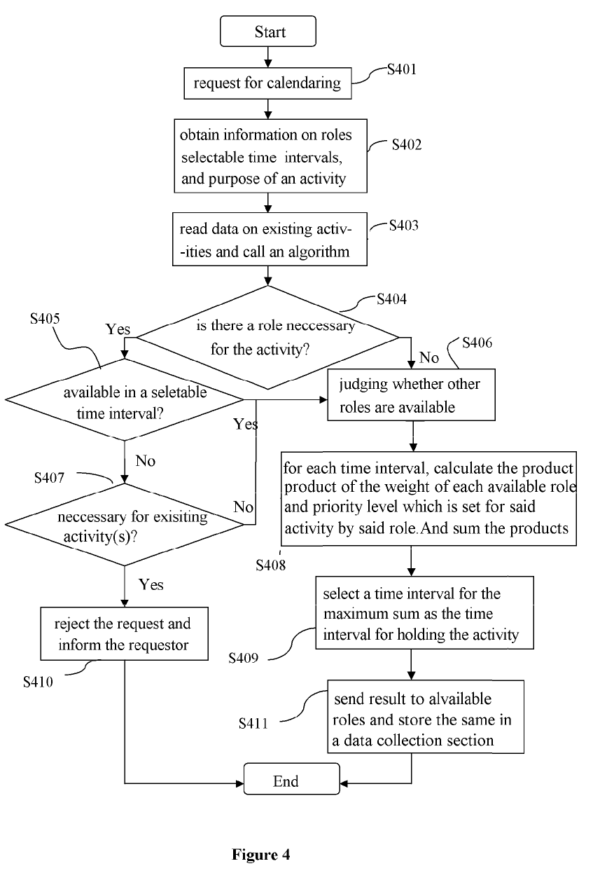

FIG. 4 shows a flowchart of the calendaring method in another embodiment according to the invention. The calendaring method shown in FIG. 4 has some of steps similar to those included in the calendaring method shown in FIG. 2, so the description of those same steps will be omitted for briefness. In the calendaring method shown in FIG. 4, at step S403, based on the inputted request including information on roles invited to attend the activity, all data on existing activities, which have been calendared for all roles invited to attend the activity in all selectable time intervals before the request being inputted, and priority levels, which are set for the type of the activity by all the specific individuals of a plurality of the roles invited to attend the activity, are read from a database, and a algorithm based on weights and roles' preferences is called from an algorithm library. The algorithm based on weights and roles' preferences according to the invention can be expressed by the following formula:

$$TS = {\sum }_{i = 1}^{n} ( TS ⋂ {TS}_{i} ) * {w}_{i} * {p}_{i} \to MAX$$

Wherein, TS is a selectable time interval, TSᵢ is a selectable time interval (s) during which the i^{th} role is available, and wᵢ is the weight of the i^{th} role for the activity, and pᵢ is the priority level which is set for the activity by the i^{th} role, which is represented by one of pure individuals of the role who sets a priority level which is the highest among all the priority levels set for the activity by all pure individuals of the role. The formula means that, multiplying the weight of each available role invited to attend the activity relative to the activity by the priority level which is set for the activity by the available role is preformed to obtain a product; the obtained products for all available roles are summed; comparing among all the sums corresponding to the selectable time intervals is performed so as to obtain the greatest sum; and a selectable time interval corresponding to the greatest sum of the products is determined as the time interval for holding the activity. Thus, at step S408, the weight of each available role invited to attend the activity relative to the activity is multiplied by the priority level which is set for the activity by the available role (i.e., the priority level which is set by one of pure individuals of the role and is the highest among all the priority levels set for the activity by all pure individuals of the role) to obtain a product, and for each selectable time interval, the products for the roles that are available during the corresponding time interval are summed. At step S409, the sums of the products corresponding to the selectable intervals are compared, and a selectable time interval corresponding to the greatest sum of the products is determined as the time interval for holding the activity.

The above method is more advantageous for those activities which are calendared in non-working days. For example, for various sport games to be held by a community, a certain role prefers a sport game such as football to in other sport games, and thereby, the role can set higher priority level to the football game. Alternatively, some roles (i.e., the specific individuals in the roles) are more interested in a kind of seminar, and therefore, they can set higher priority level to the seminar of this kind. Thus, the above optimization method can make relevant activities be calendared more properly and be held more effectively.

FIG. 5 shows a block diagram of the architecture of the calendar system according to the invention. The invention provides a calendar system 100 comprising inputting section 110, time-activity-role (TAR) modelizalion section 120, data collection section 130, algorithm library section 140, solution optimization section 150, access controlling section 160, and role terminal 170.

The inputting section 110 is used for inputting a request for calendaring an activity. In the calendar system according to the invention, the inputting section 110 can be any means for inputting the request for calendaring the activity, such as a display which can display an inputting interface, for example, PC, PDA, mobile phone, electronic mail transmitter and so on. The request inputted from the inputting section 110 include the information necessary for calendaring, i.e., role, the purpose of an activity, and an expected time interval(s) for holding the activity. Of course, the request can include other information, such as importance of the role(s) for the activity, a collection of selectable time intervals, location for holing the activity therein, apparatuses used for the activity and optimization algorithm etc. The request can be expressed by a natural language, such as “a request for holding activity A during the time interval TS from Tᵢ to Tᵣ for roles R1, R2, R3 etc.” Such request for calendaring an activity can be inputted by a request inputting interface that is specially developed for the invention.

The time-activity-role (TAR) modelization section 120 is used to receive the request for calendaring the activity which is inputted from the inputting section 110, and to modelize the request for calendaring the activity so as to form a group of modelized data for each activity of each role. The TAR modelization section 120 extracts the related information from the received request so as to modelize the request. The TAR modelization section may also be the request inputting interface that is specially developed for the invention and the interface can guides the requestor to directly input respective information items which should be included in the request according to the requirement of modelization. FIG. 6 shows a model view of the above modelized data structure collected and stored in the data collection section implementing the invention.

As shown in FIG. 6, the model is three-dimensional model, wherein three axes represent respectively role (R), activity (A), and time (T). The model can be used for some communities to calendar collaboratively. In order to modelize the data, usually, the calendaring system will assign each role in the community using the system a number such as R1, R2, and R3 . . . . The time axis is measured according to the time measuring method of the Gregorian calendar. Of course, a community using the calendar system of the invention can measure the time axes according to a traditional or conventional way of counting the years in the country or area where it locates, such as lunar calendar in China. In the invention, the time interval is a time slot, and in TAR model, the time is represented by the time axis and one time interval TS can be expressed by the following formula:

TS=[Tᵢ,Tᵣ] T₁εTime and TᵣεTime and T₁≦Tᵣ

The data collection section 130 collects and stores all the data on the existing activities which have been calendared successfully by the calendar system of the invention before the activity is requested for being calendared. All the data are stored in the data collection section 130 in a modelized data structure. Of course, the data on the corresponding relationship between all the roles of the community using the invention and the role number, the pure individuals constituting each role in the community, the level or priority level of each individual in the corresponding community are also stored in the data collection section 130.

The algorithm library section 140 is used to store various algorithms related to the calendaring and call corresponding optimization algorithm in response to the request. The algorithm library section 140 includes various algorithm programs or circuits. These algorithms correspond to the methods for performing optimization process. The algorithms which are usually used by optimization process based on roles according to the invention include, for example, an algorithm of maximizing the weighted sums, an algorithm of maximizing the number of roles based on the maximization of the weighted sums, or an algorithm based on weights and roles' preferences etc. These algorithms have been described in details before. Of course, the optimization process methods listed above are not for purpose of limitation. The person skilled in the art can complement various optimization process methods based on the invention. The solution optimization section 150 is used to receive the modelized request for calendaring an activity from the TAR section 120, in response to the request, read the data on existing activity(s) which has been previously calendared and is associated with the request from the data collection section 130 and call corresponding algorithm from the algorithm library section 140, and then perform optimization process for calendaring and output the optimized calendaring result. In the invention, the solution optimization section 150 uses the TAR function to perform optimization process for the calendaring. The TAR function is a quintuple function, and can be expressed by the following formula:

TAR=(TS,A,R,δ,θ)

In the formula, TS is a selectable time interval, A represents activities, R represents roles, δ is a function used to judge the availability of the role (which has been described in details before), and θ represents optimization function (which has been described in details before).

The above TAR function used by the solution optimization section 150 means that, the solution optimization section obtains information on roles and selectable lime intervals related to the activity included in the request, and information on roles invited to attend existing activity(s) (i.e. the pure individuals therein) and time intervals for holding the existing activity(s), judges the availability of the role for the activity based on the above obtained information, and applies an optimization function to the roles to attend the activity and the selectable time intervals for holding the activity so as to perform the optimization process.

In addition, the calendar system further includes an access control section 160. By the access control section 160, the calendar system can be defined as a private calendar system or a public calendaring system. The private calendar system is exclusively owned by each pure individual and other individuals have no rights to access or update it, but can know its existence (can not know its detailed contents). The public calendar system is shared in the entire community, and all roles in the community have the right to access the public calendaring system, but only the calendar system owner or authorized individual has the right to update it. Upon requesting for calendaring an activity, the calendar requestor can select calendar as a private activity or a public activity according to a prompt given by the access control section 160 in the calendar requesting system, and the calendar system will determine to enter the private calendar system or the public calendar system based on the selected result, and thereby determine whether the result of calendaring is a private calendar or a public calendar. Also, in general, each pure individual maintains their private activity list by themselves, and the private activity list can be only used in this private calendar system. However, the private activity can be requested to be upgraded to a public activity, and the access control section 160 determines whether the private activity is to be upgraded to a public activity according to the upgrading request. Although the private activity can be only used in the private calendar system, no matter whether in calendaring a private activity or calendaring a public activity, these date on the private activity will be taken into account as constituent parts of the data on existing activity(s) which has been calendared for the pure individuals, that is, the calendaring requestor can know the existence of the private activity.

The description of the present invention has been presented for purposes of illustration and description, and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A method for calendaring, comprising the steps of:
acquiring a request for calendaring an activity for a plurality of roles invited to attend the activity;
acquiring data on existing activities which have been calendared for a group of specific individuals in the plurality of roles invited to attend the activity; and
determining a time interval for holding the activity based on the acquired data on existing activities which have been calendared for the group of specific individuals in the plurality of roles invited to attend the activity and based on the acquired request for calendaring the activity.

2. The method according to claim 1, wherein the step of acquiring a request for calendaring the activity comprises:
acquiring roles invited to attend the activity; weight of each role relative to the activity, wherein the weight corresponds to an importance of the role for the activity; and a plurality of selectable time intervals for holding the activity.

3. The method according to claim 2, wherein the step of determining a time interval for holding the activity comprises:
judging availability of each role invited to attend the activity based on the acquired data on the existing activities that have been calendared for the group of specific individuals in the plurality of roles invited to attend the activity;
summing weights of all the roles available to the activity for each one of the plurality of selectable time intervals; and
selecting the time interval for holding the activity corresponding to a maximum of the summed weights.

4. The method according to claim 2, wherein the step of determining a time interval for holding the activity comprises:
judging availability of each role invited to attend the activity based on the acquired data on the existing activities that have been calendared for the group of specific individuals in the plurality of roles invited to attend the activity;
summing weights of all the roles available to the activity for each one of the plurality of selectable time intervals;
calculating differences between a maximum of all the summed weights and each individual summed weight;
selecting a summed weight, from a group of summed weights whose difference from the maximum of all the summed weights is less than a predetermined threshold, which has the most number of roles available to the activity; and
determining a selectable time interval corresponding to the selected summed weight as the time interval for holding the activity.

5. The method according to claim 2, wherein the step of determining a time interval for holding the activity comprises:
judging availability of each role invited to attend the activity based on the acquired data on the existing activities that have been calendared for the group of specific individuals in the plurality of roles invited to attend the activity;
calculating respective products of weights, of each available role invited to attend the activity relative to the activity, and priority levels, set by each of the group of specific individuals who constitute corresponding available roles invited to attend the activity;
summing the calculated products for each of the plurality of the selectable time intervals; and
determining a selectable time interval corresponding to a greatest of the calculated products as the lime interval for holding the activity.

6. The method according to claim 3, wherein the step of judging availability of each role invited to attend the activity comprises judging availability of each of the group of specific individuals who constitute the corresponding roles invited to attend the activity.

7. The method according to claim 3, wherein the step of judging availability of each role invited to attend the activity comprises:
judging whether there are roles necessary for the activity in the plurality of roles invited to attend the activity; and
terminating the calendaring of the activity if the roles necessary for the activity are also necessary for the existing activities, which have been calendared to be held during the plurality of selectable time intervals for the roles necessary for the activity.

8. The method according to claim 3, wherein the step of judging availability of each role invited to attend the activity comprises:
judging whether there are roles necessary for the activity in the plurality of roles invited to attend the activity; and
determining that the roles necessary for the activity are available to the activity during one or more of the plurality of selectable time intervals, if the roles necessary for the activity are not necessary for the existing activities that have been calendared to be held during the respective one or more selectable time intervals for the roles necessary for the activity.

9. The method according to claim 1, further comprising informing the group of specific individuals, in the available roles invited to attend the activity, of results of calendaring the activity.

10. The method according to claim 9, further comprising:
modeling data from the results of calendaring the activity; and
storing the modeled data.

11. The method according to claim 10, wherein the step of modeling data comprises modeling the data from the results of calendaring the activity in a form through applying a Time-Activity-Role model.

12. A system for calendaring, comprising:
an inputting section for inputting a request for calendaring an activity for a plurality of roles invited to attend the activity;
a data collection section for collecting and storing data relevant to the calendaring; and
a calendaring section for acquiring the request from the inputting section, for acquiring data from the data collection section on existing activities that have been calendared for a group of specific individuals in the plurality of roles invited to attend the activity, and for determining the time interval for holding the activity based on the data on the existing activities.

13. The system according to claim 12, wherein the calendaring section further comprises a Time-Activity-Role (TAR) modelization section for receiving the request for calendaring the activity inputted from the inputting section and for modeling the request for calendaring the activity.

14. The system according to claim 13, wherein the calendaring section further comprises a solution optimization section, through which an optimization process of calendaring can be performed and a substantially optimized calendaring result can be outputted.

15. The system according to claim 14, wherein the calendaring section further comprises an algorithm library for storing multiple optimization algorithms, and for calling an optimization algorithm from the algorithm library in response to the request, wherein the called optimization algorithm is adapted for;
acquiring a request for calendaring the activity for a plurality of roles invited to attend the activity;
acquiring data on existing activities which have been calendared for all the specific individuals in the plurality of roles invited to attend the activity; and
determining a time interval for holding the activity based on the data on existing activities which have been calendared for all the specific individuals in the plurality of roles invited to attend the activity and the request for calendaring the activity.

16. The system according to claim 15, wherein that the algorithm library comprises an algorithm of maximizing a plurality of summed weights, an algorithm of maximizing the number of roles based on maximization of the summed weights, and an algorithm based on summed weights and preferences of the roles.

17. The system according to claim 12, further comprising a plurality of private calendar systems and one public calendaring system.

18. The system according to claim 17, further comprising an access control section that controls the rights of the group of specific individuals for accessing and updating the system and for upgrading a private activity to a public activity.
